(19) United States
(12) Patent Application Publication
(10) Pub. No.: US 2015/0268974 A1
(43) Pub. Date: Sep. 24, 2015

(54) Method for controlling separate running of linked program blocks, and controller

(71) Applicant: CONTINENTAL AUTOMOTIVE GMBH, HANNOVER (DE)

(72) Inventors: Andre Goebel, Regensburg (DE); Thomas Petkov, Ergolding (DE)

(21) Appl. No.: 14/434,175

(22) PCT Filed: Oct. 4, 2013
(86) PCT No.: PCT/EP2013/070696

§ 371 Date: Apr. 8, 2015

(30) Foreign Application Priority Data
Oct. 9, 2012 (DE) 10 2012 218 363.9

(51) Int. Cl. G06F 9/445; G06F 12/14

(52) U.S. Cl. CPC G06F 9/44552; G06F 12/1458; G06F 2212/1052

(57) ABSTRACT

A method controls separated running of linked program blocks which are configured for implementing functions of safety-relevant systems. A first program block is executed on a processor, the first program block being present in a first portion of a memory. A second program block is called during the execution of the first program block. The second program block is present in a second portion of the memory, which is different from the first portion. Access to the memory is monitored by a memory protection device, which initiates an exception if it is determined that the second program block is called during the execution of the first program block. An exception handler locks the first portion upon occurrence of the exception and releases the second portion for execution. The access to data is controlled by the memory protection device by use of exceptions and of the locks and releases resulting therefrom.

The present invention relates to the control of safety-relevant systems in motor vehicles by means of a processor and relates particularly to the control of separate running of linked program blocks that are used to implement functions of the safety-relevant systems.

### PRIOR ART

It is known practice for safety-relevant functions, particularly functions for engine control, to be provided by means of a data processing apparatus, with a processor of the data processing apparatus processing a program that can run on the processor. Since erroneous functions have immediate effects on the safety of the vehicle, safety measures are applied when producing the program sections. Different program sections can also belong to different safety levels, so that various program sections or subroutines are associated with different classes. ISO standard 26262 provides a total of five different categorizations for motor vehicles, which are referred to as ASIL A-D or QM. In order to be able to ensure the safety level of every program section even when running on the processor, it is necessary for program sections with different safety classification not to influence one another while running.

In order to ensure this separation of running, explicit switch commands from a superordinate sequence control system are used, or are executed as individual processes of the bottommost system level (tasks). In accordance with a further known approach, a plurality of processor cores are used, each core being associated with a particular safety class, so that only subroutines with a particular safety classification run on a particular core and not on the other cores. These approaches are inefficient, since they require additional computation outlay or elaborate processor architectures.

It is therefore an object of the invention to demonstrate a strategy that can be used to execute subroutines with different safety classification separately in an efficient manner.

### DISCLOSURE OF THE INVENTION

This object is achieved by the subject matter of the independent claims. Further advantageous aspects emerge from the features of the dependent claims.

Instead of nonsecure separation just on the basis of tasks, processor cores or by means of ineffective changeover by a superordinate program, as proposed by the prior art, provision is made for the running of linked program blocks to be separated by means of a memory monitor. Program blocks or data to be separated are provided in a wide variety of sections of the memory. In this context, program blocks are provided in what are known as sections in a memory while data are provided in more specifically denoted data sections of a memory. The separation is achieved by virtue of program blocks or data that need to have their running or access separated being provided in different sections. A memory monitor, particularly a memory protection device, only ever enables the currently running section or the current data section, while other sections or data sections have access disabled. In particular, the memory monitor blocks only write access to data, whereas read access by the memory monitor may be possible. In respect of data, the disablement may therefore be write disablement. If a further program block is called in a manner crossing over between sections or data are accessed in a manner crossing over between data sections, the memory monitor triggers an exception. On the basis of this exception, the section or data section that belongs to the called, new program block is enabled and the previous section or data section, which belongs to the calling program block, is disabled.

The mechanism described here is therefore based on the use of a memory protection device that detects crossover between program blocks or data that are actually to be separated and triggers an exception. On the basis of this exception, the exception handler changes the enablement or disablement, so that other data or program blocks are accessible or executable. The exception handler therefore only ever activates one type of program blocks or data by virtue of the relevant section or data section being enabled while others are disabled. In order to distinguish the data or program blocks in terms of safety level, the data or program blocks are stored in different data sections or sections according to their safety level.

This separation of the program blocks or data into different sections or data sections is used by the memory monitor as a distinguishing feature by means of which the different safety levels are detected. The separation in terms of execution and access is provided by the enablement and disablement on the basis of the exception that has occurred.

Therefore, a method for controlling separate running of linked program blocks is disclosed. The program blocks whose separate running is controlled are linked by virtue of the course of a program block involving a further of the program blocks being called. In particular, within a program block, a further program block is called as a subroutine, for example as a function or as a procedure that is part of the calling program block or else an interrupt. When a program block is called as a function, parameters can be forwarded from a calling program block to the called program block. The program blocks are referred to as calling program block and as called program block, with the calling program block also being able to be referred to as first program block and the second program block being able to be referred to as called program block. However, the latter association is dependent on the current situation of the call and can change. A calling program block can, in particular, also call a plurality of program blocks, so that on the basis of the method one or more second program blocks exist. In addition, a plurality of calling program blocks can exist to call one or more program blocks that may be different. There therefore exist(s) one or more first program blocks.

Interrupts can be regarded as a program block or as a subroutine (as described herein). This can also apply when a program block provided as an interrupt or a subroutine provided as an interrupt is not called explicitly but rather is executed or triggered in another way.

A program block that is called by a first program block can likewise call one or more further program blocks. Therefore, the attributes called, calling, first and second program block are each situation-dependent and denote the hierarchy between two program blocks for the situation of a call. For the situation of a further call, the (relative) hierarchy may be another, which means that the denotations accordingly also change depending on the situation of the call.

The program blocks are designed to implement functions of safety-relevant systems in motor vehicles. In particular, the program blocks are designed to implement functions in the region of a drive train or functions of the drive train or functions of further vehicle-specific applications such as steering systems or vehicle or occupant safety systems, for example functions of an internal combustion engine, of an electric motor that is used for traction in the motor vehicle, of an electrical, electromechanical or mechanical braking apparatus of the motor vehicle, or of an electrical steering drive. Further functions relate to the visual or audible display of operating states that are states of the functions cited at the outset.

Examples of such functions as are implemented by the program blocks are additionally the control of the quantity of fuel, of the air volume, of the fuel makeup, of the injection instant and/or of the ignition instant of an internal combustion engine in the motor vehicle. Further functions are recuperation time and recuperation power for an electric motor that is used to recover kinetic energy from a vehicle and/or the commutation of an electric motor used for traction, particularly commutation instant, excitation current level and possibly phase offset between the excitation current level and the voltage applied to the electric motor.

The method provides for the first of the program blocks to be executed on a processor. The executing processor can have one or more processor cores. The processor is preferably a microcontroller, particularly a microcontroller designed for safety-critical systems, for example a microcontroller designed for engine controllers. As illustrated in more detail below, the executing processor comprises particularly a memory protection device and also preferably an exception handler. The executing processor comprises particularly a memory or at least an interface for the connection of a memory.

An advance step may be provided that can be considered as the start of the method. Said advance step is executed particularly while the controller or method described here is starting. This advance step provides for a memory protection device to be configured in accordance with specifications that support the strategy described here. In particular, the memory protection device is configured in accordance with specifications that define sections of the memory, particularly in respect of the access rights. The advance step therefore provides for configuration of the access monitoring and particularly configuration of the access rights for the section and/or the program blocks. In addition, the advance step can be used to define which program block is stored in which section and particularly which access rights the program block or the section obtains. Within the advance step, it is also possible for the program blocks or at least one of them to be started or a superordinate program in which the program blocks are called. Starting is preferably executed after configuration.

The first program block, which is executed by the processor, is present in a first section of the memory. The processor executes the first program block by accessing the memory. During the execution of the first program block, the processor is entitled to effect read and write access to the first section. During the execution of the first program block, the processor is particularly entitled to execute programs that are present within the first section. In addition, the first program block is provided with execution rights that permit the execution by the processor.

During the execution of the first program block, a second program block from the cited program blocks is called. Said calling can occur as part of a procedure or function call, for example. In this context, the second program block can be regarded as a subroutine or interrupt of the first program block. The second program block is located in a second section of the memory. The second section is different than the first section of the memory. Different sections of the memory have no overlap.

Access to the memory and particularly access to the memory in the course of (incipient) execution of the program stored therein is monitored by a memory protection device. The memory protection device monitoring the access is particularly part of the processor and may be embodied as hardware. Alternatively, the memory protection device is embodied partly as software but runs on the processor or on a memory monitoring apparatus connected to the processor. In particular, the memory protection device may be part of a memory interface that belongs to the processor or is integrated therein. The memory protection device triggers an exception if the monitoring of the access by the memory protection device prompts ascertainment that during the execution of the first program block (i.e. of the first of the program blocks) the second section is accessed, which contains the second program block (i.e. the second of the program blocks). The memory protection device therefore monitors access to the sections into which the memory is divided. Access refers particularly to read access, preferably in the course of execution by the processor. However, access can also refer to write access or to write and read access. In one preferred embodiment, the access is access to the memory by the processor for the purpose of executing a program block (subroutine or function) that is present therein. The access can therefore correspond to execution or preparation for execution of a program block.

Since the program blocks are distributed over different sections, the monitoring can ascertain when a called program block is present in a different section than the program block that has called it.

The occurrence of the exception prompts the exception handler to disable the first section of the memory. There may also be a plurality of first sections present that are disabled. The disablement relates particularly to the type of access used, preferably to the execution, i.e. to the reading for the purpose of execution. The occurrence of the exception prompts the exception handler to enable the second section for execution. The enablement relates to the same activities as the disablement or access (reading, writing) and particularly to the execution.

In particular, the exception handler enables the second section for reading and preferably also for execution. As a result, the exception handler changes the section that contains executable program blocks and also the section that is not enabled for execution.

The disabling or enabling exception handler may be provided in the form of hardware, particularly as hardware within the processor, or as hardware that is connected to the processor. In addition, the exception handler may be present partially or completely in software that runs on the processor or on an exception processing apparatus within the processor or outside the processor with a connection to the processor. The hardware that implements the memory protection device and the exception handler, particularly the memory monitoring apparatus or the exception processing apparatus, is firmly connected to the processor and is particularly connected directly thereto in order to avoid unintentional manipulations. By way of example, the memory protection device and the exception handler are provided by a memory management unit (MMU), which is preferably again part of the processor or may be provided as hardware that is associated with the processor.

The second program block can be called by a task manager during the execution of the first program block. Preferably, however, the second program block is called by a command in the first program block, particularly by a function or procedure call in the first program block.

At the end of the execution of the second program block, a return takes place. The return is triggered particularly by a return command in the second program block or by the end of the commands that represent the second program block.

The return disables the second section and enables the first section again. This change in the access rights can be provided by a further exception that is triggered by the return. Alternatively, at the end of execution, superordinate hardware or software provides a further exception. Occurrence of the further exception or execution of the further exception prompts the exception handler to disable the second section. In addition, the occurrence or the execution of the further exception prompts the exception handler to enable the first section for execution. Disabling a section prevents the processor from processing a program block that is present in the relevant section. In particular, disabling a section disables the execution of code in this section. Enablement allows the processor to access the relevant section for execution.

According to a further aspect of the invention, during the execution of the first or second program block at least one further program block is called. In addition, the memory protection device triggers an exception when the further program block is called. In particular, the memory protection device triggers an exception when the calling program block (i.e. the first or the second program block) accesses a further section of the memory that also contains the further program block. This access to the nonenabled section triggers the exception from the memory protection device. Occurrence of this exception prompts the exception handler to disable the section of the memory that contains the calling program block. Occurrence of this exception prompts the exception handler to enable the section of the memory that contains the called program block. Following enablement, the called program block is executed by the processor. Preferably, the execution in this case begins immediately after the relevant section has been enabled.

As a result, it is possible to define more than two hierarchy levels that cannot alternately influence one another, since only one section of the memory is enabled for the execution of the processor, rather than a plurality.

According to a further aspect, access to the second section is continuously disabled while the first program block is executed. In this case, access is disabled by the memory protection device. Access to the first section is continuously disabled while the second program block is executed. In this case too, the memory protection device disables access to the section. The access in this case is particularly access for executing a program block. Finally, the disablement means that write access to the disabled section of the memory is blocked by the memory protection device.

A further aspect of the method disclosed here relates to the access rights to data, while, in contrast thereto, the preceding passages essentially refer to sections that contain program blocks. A preferred method is executed within a hardware structure in which sections of the memory that store program blocks are separate from sections of the memory that contain data. If this separation is not provided, the preceding description relates to sections that contain not only program blocks but also data associated therewith. In addition, the disclosure in relation to program blocks also applies to data, and vice versa.

The first program block has an associated first data section for data that are stored by the first program block and read. The second program block (and every further program block) has at least one associated second data section, which is different than the first section, for data that are stored by the second program block and read. The program blocks may also have a plurality of associated first or a plurality of associated second data sections. The data sections may be provided in the same memory as the sections that contain the program blocks. According to a specific embodiment, various memories are provided, wherein one memory comprises only sections in program blocks and a further, different memory comprises only data sections.

A section that stores program blocks and a data section refer to logical groups or sections of the memory that are mapped particularly onto physical segments or pages. Logical groups or sections are sections of a memory with a variable size; in particular, the size may be different for different program blocks (or segments or groups).

In addition, the size of the data sections may be different than the sizes of the sections that contain the program blocks. Moreover, the positions of the data sections may be different than the positions of the sections that contain the program blocks.

The exception handler disables the first data section when calling of the second program block by the first program block triggers an exception. The exception handler disables the second data section when calling of the first program block by the second program block triggers an exception. In addition, that data section that is associated with a calling program block is disabled. That data section that is associated with the called program block is enabled.

According to a further aspect of the invention, the first program block has a different associated safety level than the second program block. In the same way, the safety levels that are associated with the first and second data sections differ. The safety level is preferably geared to ISO standard 26262. In particular, the program blocks are formed on the basis of ISO standard 26262. In addition, provision is made for the program blocks to be classified in accordance with the ASIL categorizations A-D or QM. The first and second program blocks are classified differently in this case.

In particular, a section only ever contains program blocks having the same classification. Data sections are also only ever associated with one or more program blocks having the same certification. The distinction on the basis of the classification thus allows simple memory protection measures to achieve separation of the relevant program blocks or data in order to separate program blocks or data and different safety classes from one another without influence. Besides exemplary classification in accordance with ISO standard 26262, functionally relevant data or program blocks that are calibration data or are associated with a read-only memory, for example, can be separated from other program blocks or data without influence, to which program blocks or data this does not apply and hence for which program blocks or data another safety categorization applies. By way of example, the classification may comprise one or more of the following criteria:
(a) Code developed in accordance with prescribed development processes, or not
(b) Code produced by a predefined group of developers or manufacturers, or not
(c) Plausibility check executed during runtime, or not
(d) Data check executed during runtime, or not
(e) Code and data input/output formally verified, or not, possibly by means of single command run
(f) Code checked by a further device, or not
(g) Limited pointer use, or not
(h) Code statistically analyzed, or not
(i) Model examinations for the code performed, or not
(j) Control sequence is monitored, or not
(k) Reciprocal consistency check between model and code performed, or not
(l) Code produced with different software designs, or not
(m) Monitoring unit provided, or not
(n) Independent parallel redundancy provided, or not
(o) Error injection test executed, or not
(p) Resource use test executed, or not
(q) Redundant storage of calibration data provided, or not
(r) Error recognition and/or error correction codes in place, or not.

According to a further aspect, the exception is what is known as an interrupt or what is known as an exception, particularly a hardware interrupt or a software interrupt. In addition, the interrupt is triggered and/or processed inside or outside the processor. The interrupt may be maskable or unmaskable.

In addition, as a specific embodiment, an exception that is triggered when a program block calls a program block with a different and, in particular, higher safety level is executed with a different and, in particular, higher priority than an exception that is triggered when a program block calls a program block with a different and, in particular, lower safety level. The exception handler executes the exceptions in accordance with these priorities. The priority of the execution of the exception is therefore dependent on the safety level of the called program block. The lower the safety level of the called program block, the lower the priority of the thereby triggered exception by means of the exception handler. This embodiment above relates to the specific case in which the memory protection device is set up to execute a plurality of exceptions and there is additionally provision for an exception to be able to occur or be triggered even when an exception has already been triggered that has not yet been executed.

In addition, a controller, particularly for vehicles or for other applications described here, having a data processing apparatus is described. The data processing apparatus comprises a memory, a processor and a memory protection device. The controller is suited to providing the functions described above with reference to the method. In particular, the controller is therefore a gearbox controller, a drive train controller, for example for hybrid vehicles, an engine controller for internal combustion engines, particularly an engine control unit (ECU). The memory, the processor and the memory protection device can be embodied as illustrated within the context of the method.

The memory is connected to the processor, so that the processor can read and call program blocks and/or data from the memory and can store them therein. A first program block and a second program block are stored in the first and second sections of the memory. The first and second sections of the memory are different than one another. The sections store one or more first or one or more second program blocks, with first program blocks being stored in different sections than second program blocks. The first and the at least one second program block are linked to one another. In particular, the first program block contains a call to the at least one second program block.

The data processing apparatus comprises a memory protection device, the programming of which or the connection of which to the memory prompts the memory protection device to trigger an exception when the first program block, which is stored in the first of the sections, calls the second program block, which is stored in the second section. To this end, as noted above within the context of the method, the memory protection device can be realized by means of hardware, software or a combination of these. The data processing apparatus additionally has an exception handler that is connected to the memory protection device for the purpose of receiving the exception. The exception handler is connected to the memory and set up to be prompted by the reception of the exception to disable a logical connection between the first section of the memory and the processor. The exception handler is additionally set up to be prompted by the reception of the exception to enable a logical connection between the second section of the memory and the processor in order to execute the second program block on the processor. The exception handler may also be in the form of hardware, software or a combination of these.

Preferably, both the exception handler and the data processing apparatus are part of the processor or are formed by hardware components that are connected directly to the processor.

In particular, the exception handler may be set up to disable and enable logical connections between the processor and the data sections of the memory, as illustrated above with reference to the method.

According to a further aspect of the controller disclosed here, the first program block has a different safety level than the second program block. In particular, the program blocks are formed on the basis of ISO standard 26262. The program blocks are additionally classified in accordance with the ASIL categorizations A-D or QM. The first and second program blocks are classified differently.

The memory may contain a plurality of program blocks having the same safety level, as described above with reference to the method. In addition, the first and/or the second program block, which are stored in the memory, may contain a plurality of calls to program blocks that belong to a different safety level than the calling program block in question.

The memory protection device can also be referred to as a memory protection unit, MPU. The memory protection device may be part of a memory management unit, which is also referred to as an MMU. In particular, a memory protection register is provided that stores addresses that define the limits of the sections or data sections of the memory. In this regard, output addresses and offsets may be stored, for example. The memory protection register is connected to the memory protection device or part of the memory protection device. The memory protection register therefore defines the sections that are separate from one another in respect of running or access, and calls or access operations that cross over prompt an exception to be triggered. This exception results in the active section being changed, i.e. in the section that is enabled being changed. Consequently, the exception also results in the disabled sections being changed. The data stored in the memory protection register may be defined by a linker that is executed in the course of the production of the program blocks. Said linker and the control information with which said linker is operated define the sections and therefore realize a substantial portion of the invention. The memory protection register can have one or more address ranges for specific protection modes. Protection modes are read-only enablement, write-only enablement and, in particular, disabled access. For the definition of the sections that store the program blocks, it is possible to use a different subregister than for the data sections, the subregisters being associated with the memory protection register. In addition, a subregister that stores the protection modes may be provided. In particular, the protection modes may be stored separately for the data and the program blocks.

A program block refers to a logically contiguous code that is not necessarily stored in the memory as a signal sequence. Instead, a program block may be stored physically in a plurality of different subsections of the memory as far as a memory management unit for executing the program block is available that provides the logical connection to a single program block.

The memory/memories or data memory/memories may be write-once or write-many memories. In particular, the memories may be read-only memories. The memory/memories are, in particular, hardware memories that are integrated preferably at least to some extent in the processor. The processor may, in particular, be a microcontroller of the Aurix family from the manufacturer Infineon or a microcontroller of the MPC57xx family from the manufacturer Freescale.

### BRIEF DESCRIPTION OF THE DRAWINGS

FIG. 1 shows a symbolic representation of a memory to explain the change of processing, according to the method, for the program blocks stored therein;

FIG. 2 shows a symbolic representation of an embodiment of the controller disclosed herein.

### DETAILED DESCRIPTION OF THE DRAWINGS

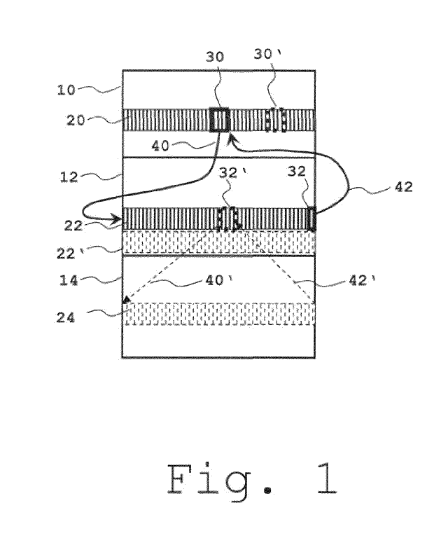

The memory shown in FIG. 1 is split into three sections 10, 12, 14. The sections store program blocks 20, 22, 22′, 24. Each section 10-14 respectively stores program blocks with a specific classification.

By way of example, all program blocks in the section 10, i.e. the program block 20, are associated with first safety level, while the program blocks 22, 22′ in the section 12 are associated with another safety level, and in turn the program block 24 in the section 14 is associated with a further safety level, which is different than the program blocks 20, 22, 22′. First of all, program block 20 is executed, which can be referred to as the first program block or the calling program block. Within the program block 20, there is a call 30 that is used to call the program block 22 in the section 12. By way of example, the call 30 is a function call, while the program block 22 implements this function. The call 30 accesses the section 12, which is different than the section 10.

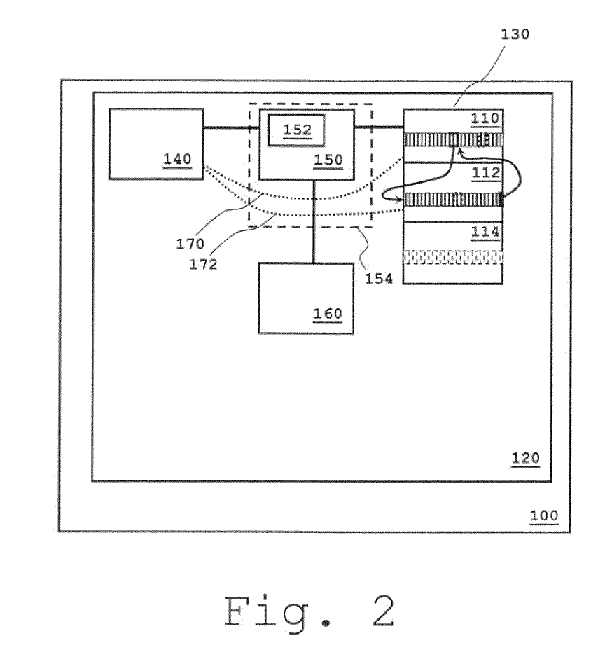

As a result of the call, a memory protection device (shown in more detail in FIG. 2) triggers an exception. The memory protection device monitors the memory shown in FIG. 1 in order to ascertain access operations in a manner crossing over between sections and possibly to trigger an exception when a section is accessed that does not correspond to the section in which the currently executed program (in the specific case program block 20) is executed.

An exception handler (shown in more detail in FIG. 2) detects this exception and disables the first section 10. In addition, the exception handler, preferably at the same time as or after the disablement, enables the section 12 for access and particularly for execution by a processor (shown in more detail in FIG. 2).

As soon as the section 12 that contains the program block 22 is enabled, it is executed. The program block 22 can therefore be referred to as second program block or as called program block.

At the end of the execution of the second program block 22, there is a return command 32, which can likewise be considered to be a call. The call 32 calls the first program block 20 again. In this situation, the second program block 22 is the calling program block and the program block 20 is the called program block. The memory protection device detects the call in a manner crossing over between sections, and triggers an exception, as a result of which the exception handler disables the call to or execution of the section 12 and the program blocks stored therein and enables the section 10 and the program block 20 stored therein for execution or for access. The processor then continues to execute the program block 20, in accordance with the return address of the call 32, which acts as a return command.

The arrows 40, 42 clarify the running and the sequential execution of the program blocks 20 and 22. The arrow 40 shows that the execution by the call 30 passes over to the program block 22. The arrow 42 shows that after the return command 32 the program block 20 continues to be executed, namely with the code following the call 30 within the program block 20. The arrows 40, 42 show how a change occurs from a program block in one section to the program block in another section. The arrow 40 depicts the call to a subroutine by a main program, the main program being represented by the program block 20 and the subroutine being represented by program block 22.

Further optional components or method steps are shown in dashes. The call 30′ to the program block 20 corresponds to a further call within the program block 20. The latter call can call further program blocks (not shown).

It is additionally shown that the program block 22, as a subroutine, can comprise a further subroutine call 32′ that calls a further code block 24 in a further section 14. The arrows 40′ and 42′ depict the change of the program block to be executed and hence of the section enabled for execution. Arrow 40′ depicts the enablement of the section 12 changing to section 14, while section 12 is disabled and the disablement of the section 14 is lifted. The arrow 42′ depicts how the execution of the program block 24 is followed by a return to the call 32′ to the program block 22. The change can therefore be performed over more than two sections of the memory, with the changes being performed in accordance with the method.

The first change in the example from FIG. 1 is depicted by arrow 40, the second change is depicted by arrow 40′, the third change is depicted by arrow 42′ and the fourth change is depicted by arrow 42. The arrows 42, 42′ go back to return commands that may be part of the program block or are executed by an execution controller if the program block in question has been executed completely. The arrows 40, 40′ go back to calls to program blocks in a manner crossing over between sections and show the changes that arise as a result of calls to (the beginning of) a program block, i.e. as a result of procedural function calls.

By way of example, the program block 22′ shows that one and the same section may contain a plurality of program blocks, namely the program blocks 22 and 22′. If the program block 22 calls the program block 22′ (not shown), the memory protection device does not trigger an exception, since the call does not cross over between sections.

FIG. 2 shows a symbolic representation of an embodiment of a controller 100 that is disclosed here. The controller 100 comprises a data processing apparatus 120. The data processing apparatus 120 comprises a memory 130, which may be in the same form as the memory in FIG. 1, in particular. The memory 130 is split into sections 110, 112 and 114, each of which have different safety levels associated with them. In particular, the program blocks within the sections are provided with a safety level that is the same for each section, the safety levels of program blocks in different sections 110-114 being different.

In addition, the data processing apparatus 120 comprises a processor 140 that accesses the memory. The logical connection that symbolizes the access is shown by the connections 170, 172 (in dotted lines).

The data processing apparatus 120 of the controller 100 additionally comprises a memory protection device 150. The latter is equipped with a memory protection register 152 that defines the sections of the memory 130 and particularly the limits thereof.

The memory protection register 152 may also be provided outside the memory protection device 150 as a register, preferably inside the data processing apparatus, which register is connected to the memory protection device 150 directly or indirectly.

The data processing apparatus 120 additionally comprises an exception handler 160. On the basis of the different functions, the components 140, 150, 160 are shown as single blocks, said blocks being able to be integrated with one another at least to some extent. In particular, the memory protection device and/or the exception handler may be integrated in the processor 140. This also applies to the memory 130. Alternatively, the memory 130 may be provided outside the processor.

The processor 140 effects read and write access to the memory 130. This access takes place via a memory management unit 154, which may likewise be integrated in the processor 130. As a result, the memory management unit 154 produces the logical connections 170, 172 that are used by corresponding access operations. It can be seen that the processor 170, 172 accesses two different sections 110, 112 of the memory 130. When the logical connection 170 exists, the memory protection device or the memory management unit 154 that contains the memory protection device 150 disables access by the processor 140 to the second section 112, so that the logical connection 172 is disabled.

If, as described with reference to FIG. 1, the second section 112 is now enabled and the first section 110 is disabled, for example by a call as shown by the reference symbol 30 in FIG. 1, then the logical connection 170 is deactivated or disabled and the logical connection 172 is enabled. The disablement and the enablement are performed by the memory protection device 150 or by the memory management unit 154.

When the execution of the program block stored in section 112 is at an end, a return is executed, cf. arrow 42 in FIG. 1. This disables the logical connection 172 and enables the logical connection 170. The execution of the program block stored in section 110 is then continued.

The disablement and the enablement are performed by means of the memory protection device 150, which uses the memory protection register 152 to identify which of the sections 110-114 of the memory 130 is currently enabled for access, and which are not.

If a program block in a second section 112 is accessed for a program block in a first section 110, the memory protection device identifies this, particularly on the basis of the memory protection register 152 and the address data stored therein, and triggers an exception. The latter is forwarded to the exception handler 160.

As a result, the exception handler 160 disables the first section by disabling the first logical connection 170 and enabling the second logical connection 172. The disablement and enablement are executed by appropriate signals from the exception handler 160 that are forwarded to the memory management unit 154 and particularly to the memory protection device 150.

### LIST OF REFERENCE SYMBOLS

10, 12, 14 Sections of the memory 130
20, 22, 22′, 24 Program blocks
30, 30′, 32, 32′ Calls, particularly from a program block that is in a different section than the called block
40, 40′, 42, 42′ Calls or return commands
100 Controller
120 Data processing apparatus
130 Memory
110, 112, 114 Sections of the memory 130
140 Processor
150 Memory protection device
152 Memory protection register
154 Memory management unit
160 Exception handler
170, 172 Logical connections between the processor and memory that are disabled or enabled by the memory management unit or by the memory protection device

1-10. (canceled)

11. A method for controlling separate running of linked program blocks configured for implementing functions of safety-relevant systems, which comprises the steps of:
executing a first program block of the linked program blocks on a processor, the first program block being stored in a first section of a memory accessed by the processor;
calling up a second program block of the linked program blocks during an execution of the first program block, the second program block being stored in a second section of the memory being different than the first section of the memory;
monitoring accesses to the memory by a memory protection device, the memory protection device triggering an exception if the monitoring of the accesses by the memory protection device prompts ascertainment that during the execution of the first program block the second program block is called; and
prompting an exception handler to disable the first section and to enable the second section for execution upon an occurrence of the exception.

12. The method according to claim 11, which further comprises executing the second program block after an enablement of the second section and at an end of the execution of the second program block a return takes place causing the second section to be disabled by the exception handler and the first section to be enabled by the exception handler for further execution, and the return triggers a further exception.

13. The method according to claim 11, which further comprises:
during the execution of the first or the second program block, calling at least one further program block stored in a section of the memory, which is different than the first and second sections for the first and second program blocks; and
triggering, via the memory protection device, an additional exception when the further program block is called, an occurrence of the additional exception prompts the exception handler to disable the section of the memory that contains a calling program block and to enable the section of the memory that contains a called program block, and the called program block is executed by the processor following enablement.

14. The method according to claim 11, which further comprises:
continuously disabling access to the second section while the first program block is executed; and
continuously disabling access to the first section while the second program block is executed.

15. The method according to claim 11, wherein the first program block has an associated first data section for data that are stored by the first program block and also read, and the second program block has an associated second data section, which is different than the first data section, for data that are stored by the second program block and also read, wherein the exception handler disables the first data section when calling of the second program block by the first program block triggers an exception, and the exception handler disables the second data section when calling of the first program block by the second program block triggers an exception.

16. The method according to claim 11, which further comprises:
providing the first program block with a different associated safety level than the second program block; and
forming the program blocks on a basis of ISO standard 26262 and are classified in accordance with an ASIL categorizations A-D or QM, the first and second program blocks being classified differently.

17. The method according to claim 11, wherein:
the exception is an interrupt;
the interrupt is at least one of triggered or processed inside or outside the processor; and
the interrupt is maskable or unmaskable, or the interrupt corresponds to a trap exception or to a fault exception.

18. The method according to claim 11, wherein an exception that is triggered when a program block calls a program block with a different safety level is executed by the exception handler with a different priority than an exception that is triggered when the program block calls the program block with the different safety level.

19. The method according to claim 11, wherein an exception that is triggered when a program block calls a program block with a higher safety level is executed by the exception handler with a higher priority than an exception that is triggered when the program block calls the program block with a lower safety level.

20. The method according to claim 12, which further comprises prompting the exception handler to disable the second section and to enable the first section for execution after an occurrence of the further exception.

21. The method according to claim 17, which further comprises selecting the interrupt from the group consisting of a hardware interrupt and a software interrupt.

22. A controller, comprising:
a data processing apparatus having a memory, a processor and a memory protection device;
said memory being connected to said processor and having a first and also at least one second program block being stored in first and second sections of said memory, said first section and said second section being different from one another;
the first and the at least one second program block are linked to one another and said memory protection device embodied with programming or with a connection to said memory that prompts said memory protection device to trigger an exception when the first program block, being stored in said first section, calls the second program block, being stored in said second section;
said data processing apparatus further having an exception handler connected to said memory protection device for receiving the exception; and
said exception handler being connected to said memory protection device and thereby being set up to be prompted by a reception of the exception to disable a logical connection between said first section of said memory and said processor and to enable a further logical connection between said second section of said memory and said processor for executing the second program block on said processor.

23. The controller according to claim 22, wherein the first program block has a different safety level than the second program block, and the program blocks are formed on a basis of ISO standard 26262 and are classified in accordance with an ASIL categorizations A-D or QM, the first and second program blocks being classified differently.

24. The controller according to claim 22, wherein the controller is a vehicle controller.
